(19) United States
(12) Patent Application Publication
(10) Pub. No.: US 2017/0170907 A1
(43) Pub. Date: Jun. 15, 2017

(54) OPTICAL TRANSMISSION DEVICE AND OPTICAL TRANSMISSION METHOD

(71) Applicant: NEC Corporation, Tokyo (JP)

(72) Inventor: Katsuhiro YUTANI, Tokyo (JP)

(73) Assignee: NEC Corporation, Tokyo (JP)

(21) Appl. No.: 15/118,349

(22) PCT Filed: Feb. 16, 2015
(86) PCT No.: PCT/JP2015/000698

§ 371 Date: Aug. 11, 2016

(30) Foreign Application Priority Data
Feb. 25, 2014 (JP) 2014-034033

(51) Int. Cl. H04B 10/532; H04B 10/50; G02F 1/01

(52) U.S. Cl. CPC H04B 10/532; G02F 1/0123; H04B 10/50575; G02F 2203/07; H04B 2210/075

(57) ABSTRACT

This invention provides an optical transmitter that internally compensates for PDL with a high degree of precision and can output high-quality transmission signals. The optical transmitter is provided with the following: a light-outputting means for generating an optical signal; a data-outputting means for outputting a data sequence generated on the basis of information to be transmitted; a driving means for applying, to an optical modulator, a bias voltage with a pilot signal superimposed thereon; the optical modulator, which, upon the application of the bias voltage, modulates the abovementioned optical signal on the basis of the aforementioned data sequence and outputs the modulated signal; and a controlling means for controlling the bias voltage in accordance with the strength of the pilot signal extracted from the modulated signal.

### TECHNICAL FIELD

The present invention relates to an optical transmission device and an optical transmission method, and more particularly, relates to an optical transmission device and an optical transmission method for combining and outputting multiple modulation signals.

### BACKGROUND ART

With the increase in the demand of broadband multimedia communication services, a polarization multiplexed method has been introduced to transmit two pieces of transmission information independent from each other in such a manner that the two pieces of transmission information are associated with two polarization states having the same wavelength but being perpendicular to each other. A digital coherent optical communication technique using a digital optical transmission and reception device is attracting attention as a longer range, large capacity, and highly reliable optical fiber communication system.

The digital optical transmission and reception device used for the digital coherent optical communication can improve the reception sensitivity by about 3 to 6 dB than an analog optical transmission and reception device using a modulation method such as OOK (on-off keying) that is generally applied in a large capacity optical communication system. Further, the digital coherent optical communication can perform wavelength distortion compensations such as a wavelength dispersion compensation and a polarization dispersion compensation by using digital signal processing (DSP: digital signal processing) at the transmission side or the reception side.

Such digital optical transmission devices use optical modulation devices capable of, e.g., multi-level modulation using QPSK (quadrature phase shift keying) modulation and QAM (quadrature amplitude modulation) modulation, and arbitrary waveform modulation using an output of a D/A (digital to analog) conversion device in order to perform pre-equalization and the like.

An MZ type optical modulation device in which an optical phase modulation device is incorporated into an optical waveguide type Mach-Zehnder (MZ) type interferometer is available as an optical modulation device used in a digital optical transmission device. For example, the MZ type optical modulation device is formed by forming a pair of optical waveguides on a surface of a substrate made of an electro-optic crystal such as lithium niobate (LN:LiNbO3) of which refractive index changes in proportional to an applied electric field strength. For example, PTL 1 discloses a digital optical transmission device using an LN modulation device.

The LN modulation device has a problem in the difference between the optical strengths of the two optical modulation signal perpendicular to each other, i.e., a polarization dependent loss (PDL). Property of transmission signals transmitted from the digital optical transmission device are degraded due to the PDL. The PDL property required for a generally-available digital optical transmission device is about +/−1.0 dB.

For example, PTL 2 discloses a polarization multiplexed optical transmission system compensating a PDL by using two different tone modulation signals. In the polarization multiplexed optical transmission system disclosed in PTL 2, two different tone modulation signals are transmitted in such a manner that the two different tone modulation signals are respectively superimposed on optical signals of X polarization and Y polarization. Then, a relay device and the like receiving the optical signal extract the tone modulation signals from the optical signal, and compensate the PDL based on a strength ratio of the two tone modulation signals.

### CITATION LIST

### Patent Literature

[PTL 1] Japanese Patent Laid-Open No. 2013-126050

[PTL 2] Japanese Patent Laid-Open No. 2012-4691

### SUMMARY OF INVENTION

### Technical Problem

However, in the polarization multiplexed optical transmission system disclosed in cited document 2, a relay device and the like receiving the optical signal compensates the PDL based on the strength ratio of the tone modulation signals. In this case, when the optical level of the received optical signal decreases, the strength ratio of the tone modulation signals decreases in proportional to the optical level, and therefore, a sufficient PDL compensation cannot be performed.

The present invention is made in view of the above problems, and it is an object of the present invention to provide an optical transmission device and an optical transmission method capable of compensating the PDL with high accuracy in an optical transmission device and outputting a high quality transmission signal.

### Solution to Problem

In order to achieve the above object, an optical transmission device according to the present invention includes an optical output means for generating and outputting an optical signal; a data output means for generating and outputting first data and second data based on transmission information; a driving means for generating two voltages based on received bias control information and generating a first pilot signal and a second pilot signal of which frequencies are different from each other, and superimposing the first pilot signal and the second pilot signal to the two voltages to output the voltages as a first bias voltage and a second bias voltage; an optical modulation device including a split means for splitting the output optical signal into two optical signals, a first modulation means driven by the first bias voltage for modulating one of the split optical signals based on the output first data, and outputting a first modulation signal, a second modulation means driven by the second bias voltage for modulating the other of the split optical signals based on the output second data, and outputting a second modulation signal, and a combining means for combining the first modulation signal and second modulation signal and outputting a modulation signal; and a control means for extracting the first pilot signal and the second pilot signal from the output modulation signal, and generating and outputting the bias control information based on a strength ratio of the extracted first pilot signal and the extracted second pilot signal.

In order to achieve the above object, an optical transmission method according to the present invention uses an optical modulation device including a split means for splitting a received optical signal into two optical signals, a first modulation means driven by the first bias voltage for modulating one of the split optical signals based on first data, and outputting a first modulation signal, a second modulation means driven by the second bias voltage for modulating the other of the split optical signals based on second data, and outputting a second modulation signal, and a combining means for combining the first modulation signal and second modulation signal and outputting a modulation signal. The optical transmission method includes generating an optical signal and outputting the optical signal to the optical modulation device; extracting a first pilot signal and a second pilot signal from the output modulation signal, and generating and outputting bias control information based on a strength ratio of the first pilot signal and the second pilot signal; generating the first data and the second data based on transmission information and outputting the first data and the second data to the optical modulation device; and generating two voltages based on the output bias control information and superimposing a first pilot signal and a second pilot signal of which frequencies are different from each other to the two generated voltages to output the voltages to the optical modulation device as a first bias voltage and a second bias voltage.

### Advantageous Effects of Invention

According to an aspect of the present invention described above, the PDL can be compensated with high accuracy in an optical transmission device, and a high quality transmission signal can be output.

### BRIEF DESCRIPTION OF DRAWINGS

FIG. 1 is a block configuration diagram illustrating an optical transmission device 10 according to a first exemplary embodiment.

FIG. 2 is a block configuration diagram illustrating an optical transmission device 100 according to a second exemplary embodiment.

FIG. 3 is a block configuration diagram illustrating a modulation device 130 according to the second exemplary embodiment.

FIG. 4A is a figure illustrating an example of an optical output strength of a modulation signal that is output from the modulation device 130 according to the second exemplary embodiment.

FIG. 4B is a figure illustrating an example of transmission data DATA that is output from a DATA driver 120 according to the second exemplary embodiment.

FIG. 5 is a simulation result of an eye pattern and a modulation signal optical output strength when an electric signal amplitude of a transmission data DATA is changed.

### DESCRIPTION OF EMBODIMENTS

### First Exemplary Embodiment

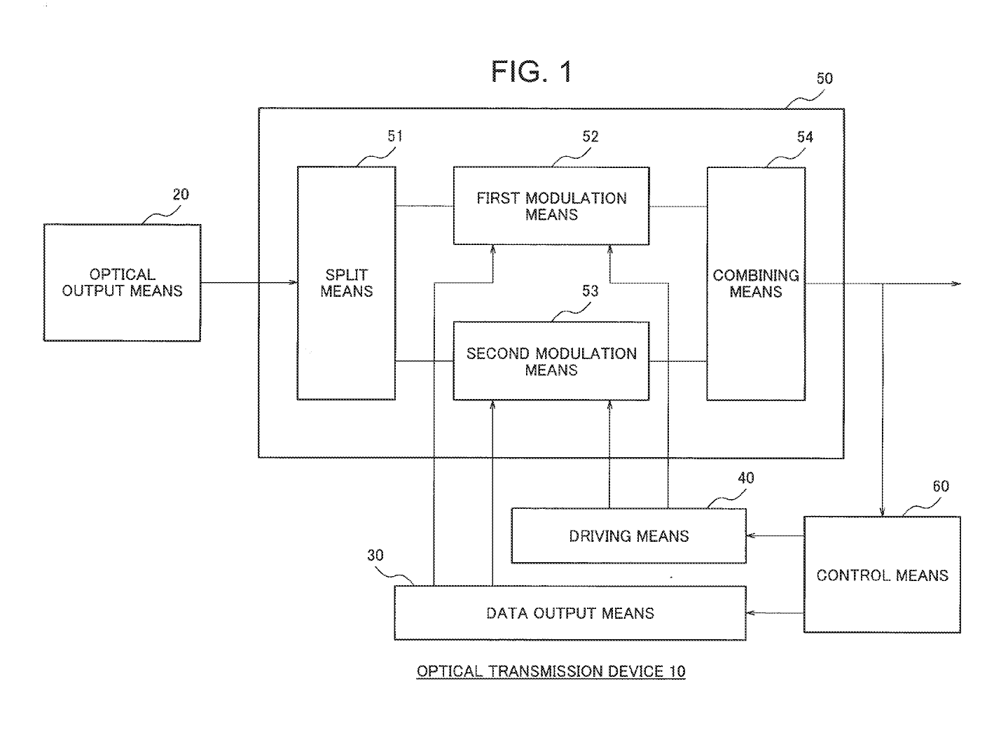

The first exemplary embodiment according to the present invention will be described. A block configuration diagram of an optical transmission device according to the present exemplary embodiment is illustrated in FIG. 1. In FIG. 1, the optical transmission device 10 includes an optical output means 20, a data output means 30, a driving means 40, an optical modulation device 50, and a control means 60.

The optical output means 20 generates an optical signal which is a basis of a transmission signal, and outputs the optical signal to the optical modulation device 50.

The data output means 30 generates the first data and the second data for modulating an optical signal based on transmission information received from the control means 60. Further, the data output means 30 adjusts the electric signal amplitudes of the generated first data and the generated second data based on amplitude information received from the control means 60, so that the electric signal amplitudes of the generated first data and generated second data attain a predetermined magnitude, and outputs the generated first data and second data to a first modulation means 52 and a second modulation means 53, respectively, of the optical modulation device 50.

The driving means 40 generates two voltages for driving the first modulation means 52 and the second modulation means 53 of the optical modulation device 50 based on the received bias control information. Then, the driving means 40 superimposes a first pilot signal and a second pilot signal, of which frequencies are different from each other, on the generated two voltages, and applies them to the first modulation means 52 and the second modulation means 53 of the optical modulation device 50 as a first bias voltage and a second bias voltage.

The optical modulation device 50 includes a split means 51, a first modulation means 52, a second modulation means 53, and a combining means 54.

The split means 51 splits the optical signal received from the optical output means 20 into two optical signals, and outputs one of the optical signals to the first modulation means 52, and outputs the other of the optical signals to the second modulation means 53.

The driving means 40 applies the first bias voltage to the first modulation means 52, and the first modulation means 52 receives the one of the optical signals that is split by the split means 51 and receives the first data that is output from the data output means 30. The first modulation means 52 is driven by the first bias voltage, and modulates the one of the split optical signals in accordance with the received first data, and outputs a first modulation signal to the combining means 54.

The driving means 40 applies the second bias voltage to the second modulation means 53, and the second modulation means 53 receives the other of the optical signals that is split by the split means 51 and receives the second data that is output from the data output means 30. The second modulation means 53 is driven by the second bias voltage, and modulates the other of the split optical signals in accordance with the received second data, and outputs a second modulation signal to the combining means 54.

The combining means 54 combines the first modulation signal received from the first modulation means 52 and the second modulation signal received from the second modulation means 53, and outputs a modulation signal.

The control means 60 outputs transmission information, which is to be transmitted to the other station in communication, to the data output means 30. The control means 60 extracts the first pilot signal and the second pilot signal from the modulation signal that is output from the optical modulation device 50. Then, the control means 60 generates amplitude information based on the strength ratio of the extracted first pilot signal and the extracted second pilot signal, and outputs the amplitude information to the data output means 30. The control means 60 calculates the electric signal amplitudes of the first data and the second data for equalizing, for example, the optical output strength of the first modulation signal that is output from the first modulation means 52 and the optical output strength of the second modulation signal that is output from the second modulation means 53. Then, the control means 60 outputs the calculated electric signal amplitudes of the first data and the second data to the data output means 30 as the amplitude information. It should be noted that the control means 60 can further generate bias control information for performing feedback control so that the strength ratio of the extracted first pilot signal and the extracted second pilot signal attains a desired value, and can output the bias control information to the driving means 40.

The optical transmission device 10 configured as described above uses the strength ratio of the pilot signals included in the modulation signal that is output from the optical modulation device 50 to perform control to adjust the electric signal amplitude of the modulation data. The electric signal amplitudes of the modulation data are adjusted in such a way that the optical output strength of the first modulation signal that is output from the first modulation means 52 and the optical output strength of the second modulation signal that is output from the second modulation means 53 are the same as each other, and this reduces the PDL occurring between the first modulation signal and the second modulation signal.

Therefore, the optical transmission device 10 according to the present exemplary embodiment can compensate the PDL within its device with high accuracy, and can output a high quality modulation signal.

In a case where the optical transmission device 10 applies a polarization multiplexed method, the split means 51 splits the optical signal into an X polarization optical signal and a Y polarization optical signal, and outputs the X polarization optical signal and the Y polarization optical signal to the first modulation means 52 and the second modulation means 53. In a case where the optical transmission device 10 performs QPSK modulation, the optical transmission device 10 may be further provided with, e.g., a pre-equalization processing means for performing various kinds of corrections and optical amplification means for adjusting the levels of the modulation signals.

### Second Exemplary Embodiment

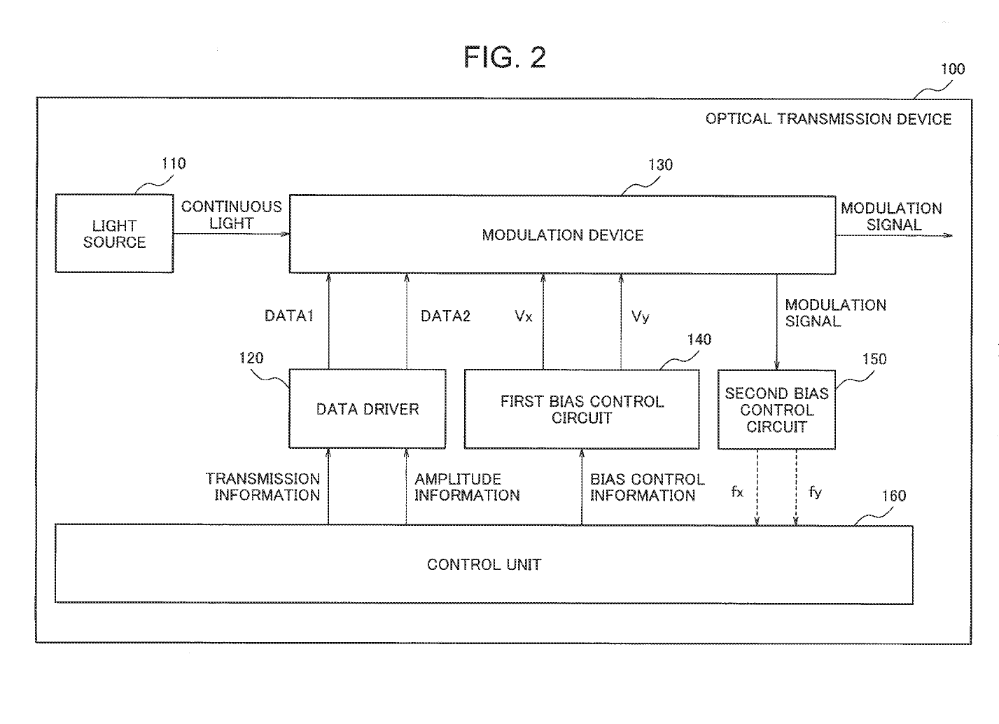

A second exemplary embodiment will be described. A configuration diagram of an optical transmission device according to the present exemplary embodiment will be illustrated in FIG. 2. In FIG. 2, the optical transmission device 100 includes a light source 110, a DATA driver 120, a modulation device 130, a first bias control circuit 140, a second bias control circuit 150, and a control unit 160.

The light source 110 generates continuous light serving as a basis of a transmission signal, and outputs the continuous light to the modulation device 130.

The DATA driver 120 receives transmission information and amplitude information from the control unit 160. The DATA driver 120 encodes the transmission information received from the control unit 160 in accordance with the modulation method of the transmission signal, and generates transmission data DATA1 and DATA2 (data row). Further, the DATA driver 120 adjusts the electric signal amplitudes of the generated transmission data DATA1 and DATA2 based on the amplitude information received from the control unit 160. Then, the DATA driver 120 outputs the transmission data DATA1 and DATA2 of which amplitudes have been adjusted to a first modulation unit 132 and a second modulation unit 133, respectively, of the modulation device 130, described later.

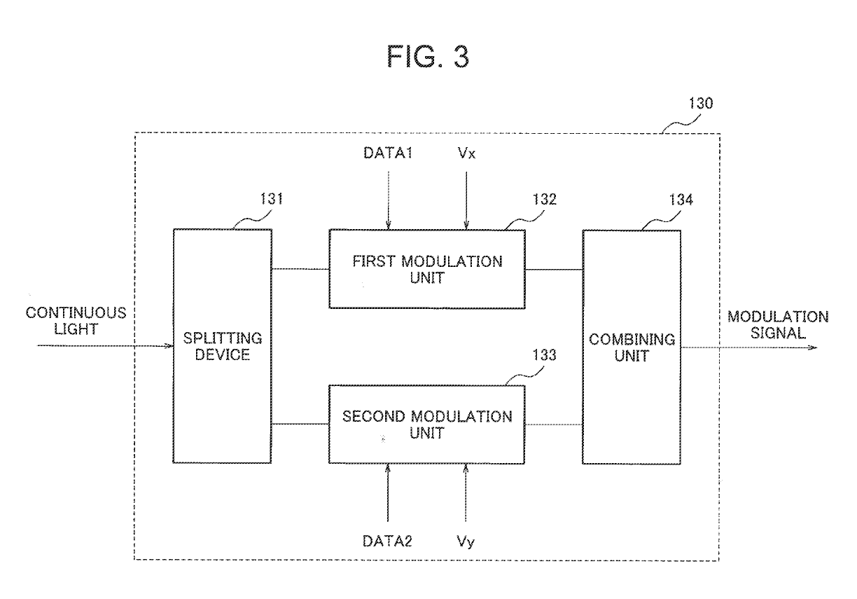

The modulation device 130 is driven by driving bias voltages Vₓ, V_{y} applied from the first bias control circuit 140, and modulates the continuous light received from the light source 110 by using the transmission data DATA1 and DATA2 received from the DATA driver 120. The block configuration diagram of the modulation device 130 will be shown in FIG. 3. In FIG. 3, the modulation device 130 includes a splitting device 131, a first modulation unit 132, a second modulation unit 133, and a combining unit 134.

The splitting device 131 splits the continuous light received from the light source 110 into two lights, and outputs one of the lights to the first modulation unit 132 and the other of the lights to the second modulation unit 133.

The first modulation unit 132 is driven by a driving bias voltage Vₓ applied from the first bias control circuit 140, and modulates the one of the received continuous lights by using the transmission data DATA1 received from the DATA driver 120, and outputs a modulation signal of X polarization.

The second modulation unit 133 is driven by a driving bias voltage V_{y} applied from the first bias control circuit 140, and modulates the other of the received continuous lights by using the transmission data DATA2 received from the DATA driver 120, and outputs a modulation signal of Y polarization.

The combining unit 134 combines the modulation signal of X polarization received from the first modulation unit 132 and the modulation signal of Y polarization received from the second modulation unit 133, and outputs a modulation signal (transmission signal).

The first bias control circuit 140 generates bias voltage V′ₓ, V′_{y} based on the bias control information received from the control unit 160, and superimposes bias control pilot signals on the generated bias voltages V′ₓ, V′_{y}. The first bias control circuit 140 applies bias voltages, on which the pilot signals are superimposed, to the first modulation unit 132, the second modulation unit 133 of the modulation device 130 as driving bias voltages Vₓ, V_{y}. The first bias control circuit 140 according to the present exemplary embodiment superimposes, as the bias control pilot signals, two pilot signals (fₓ, f_{y}) having low frequencies different from each other to the generated direct current bias voltages V′ₓ, V′_{y}.

The second bias control circuit 150 receives a part of the modulation signal (transmission signal) that is output from the modulation device 130. The second bias control circuit 150 demodulates the received modulation signal, retrieves two pilot signals (fₓ, f_{y}), and outputs the two pilot signals (fₓ, f_{y}) to the control unit 160.

The control unit 160 outputs information, which is to be transmitted to the other station in communication, to the DATA driver 120 as transmission information. The control unit 160 generates bias control information for performing feedback control of the first bias control circuit 140 based on the ratio of the output strengths of the two pilot signals (fₓ, f_{y}) received from the second bias control circuit 150, and outputs the bias control information to the first bias control circuit 140. In this case, performing feedback control of the first bias control circuit 140 based on the output strength of the modulation signal that is output from the modulation device 130 will be called ABC control (Automatic Bias Control).

The control unit 160 according to the present exemplary embodiment generates amplitude information for adjusting the electric signal amplitude of the transmission data DATA based on the ratio of the output strengths of the two received pilot signals (fₓ, f_{y}), and outputs the amplitude information to the DATA driver 120. The control unit 160 calculates the electric signal amplitudes of the transmission data DATA1 and DATA2 in such a way that the output strength of the modulation signal of X polarization that is output from the first modulation unit 132 and the output strength of the modulation signal of Y polarization that is output from the second modulation unit 133 match each other. Then, the control unit 160 outputs the electric signal amplitudes of the calculated transmission data DATA1 and DATA2 to the DATA driver 120 as amplitude information.

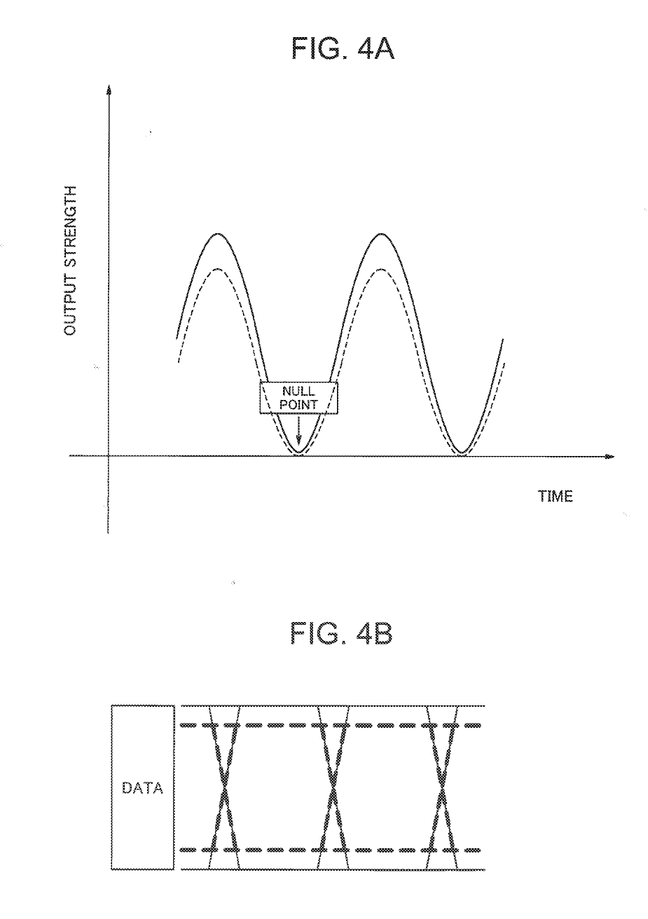

Subsequently, how the output strength of the modulation signal that is output from the modulation device 130 when the ABC control is performed will be described. An example of Vπ curve property of the modulation device 130 is illustrated in FIG. 4A.

For example, when a sine wave type driving bias voltage is applied from the first bias control circuit 140, a modulation signal having a sine wave type output strength is output from the modulation device 130. Then, when the driving bias voltage applied by the ABC control is reduced, the output strength of the modulation signal that is output from the modulation device 130 decreases (solid line to dotted line). As illustrated in FIG. 4A, the modulation device 130 is driven with a NULL point being a bias point.

Subsequently, how the output strength of the modulation signal that is output from the modulation device 130 when the electric signal amplitude of the transmission data DATA is adjusted will be described with reference to FIG. 4A, FIG. 4B. FIG. 4B is an eye pattern of the transmission data DATA in a case where the electric signal amplitude of the transmission data DATA that is output from the DATA driver 120 is changed. In FIG. 4B, the height (level) of the eye pattern is proportional to the electric signal amplitude of DATA, and a cross point (a cross point of two diagonal lines) substantially matches the position of the NULL point.

In FIG. 4B, when the electric signal amplitude of the transmission data DATA that is output from the DATA driver 120 is changed, the level of the eye pattern is reduced (solid line to dotted line), so that the output strength of the modulation signal that is output from the modulation device 130 is reduced (solid line to dotted line in FIG. 4A).

Therefore, not only the ABC control but also the control based on the electric signal amplitude of the modulation transmission data DATA are applied, so that the output strength of the modulation signal of X polarization and the output strength of the modulation signal of Y polarization can be controlled with high accuracy.

As described above, the optical transmission device 100 according to the present exemplary embodiment superimposes the pilot signal on the driving bias voltage, and controls the driving bias voltage of the modulation device 130 and the electric signal amplitude of the transmission data DATA based on the ratio of the output strengths of the pilot signals retrieved from the modulation signal that is output from the modulation device 130.

Not only the ABC control but also the control using the electric signal amplitude of the transmission data DATA are performed, so that PDL suppression with a higher level of sensitivity can be performed as compared with only the ABC control being performed. In a case where the electric signal amplitude of the transmission data DATA is adjusted by using the bias control pilot signal in order to reduce the PDL, it is not necessary to separately provide a circuit for PDL compensation. Therefore, this can reduce the increase in the size of the optical transmission device 100, and in addition, this can prevent the increase in the cost.

In a case where the PDL changes in accordance with a temperature and a wavelength, a standard value of a correction value may be set with the modulation device 130 in advance, and the electric signal amplitude of the transmission data DATA can be dynamically controlled based on the ratio of the output strengths of the pilot signals. In this case, this can prevent the control from being complicated, and can reduce the calculation load in the control unit 160.

### Embodiment

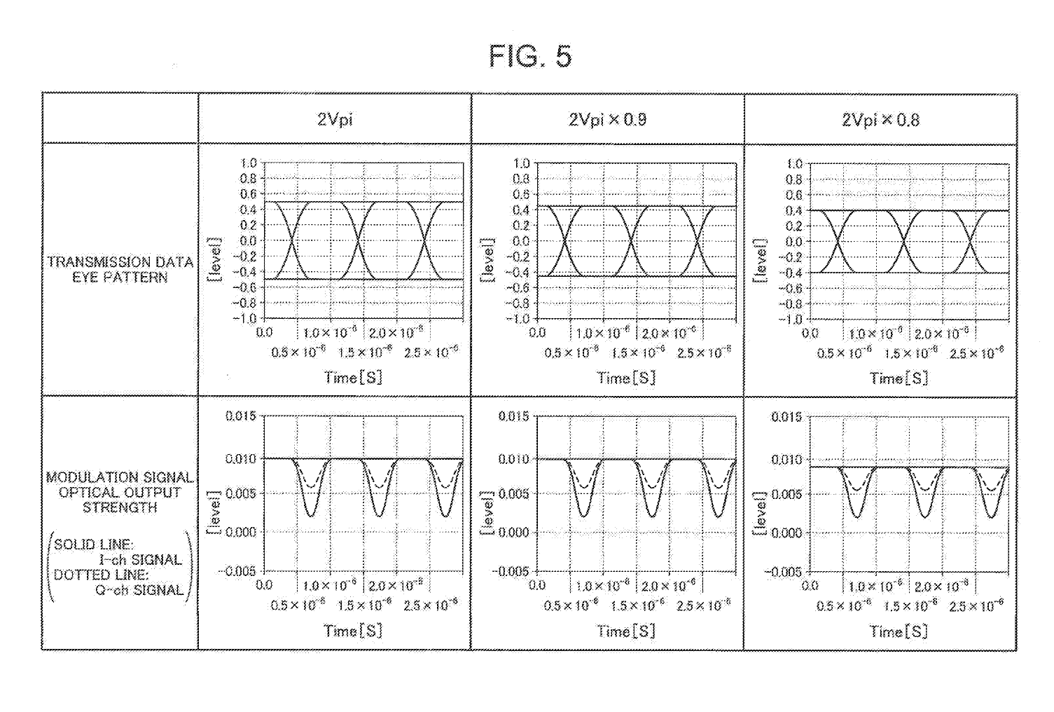

In a case where the optical transmission device 100 performs QPSK modulation, a simulation result of an output strength of a modulation signal of X polarization (I-ch signal and Q-ch signal) that is output from the modulation device 130 when the electric signal amplitude of the transmission data DATA1 that is output from the DATA driver 120 is changed will be illustrated in FIG. 5.

In a case where the optical transmission device 100 performs QPSK modulation, the modulation device 130 is constituted by two sets of optical modulation means and the like including, for example, a polarization maintaining splitter, two MZ type optical modulation device, a phase shift device, polarization multiplexing unit, and the like. Then, the X polarization I-ch transmission DATA1 and the X polarization Q-ch transmission DATA1 having the same electric signal amplitude and the Y polarization I-ch transmission DATA2 and the Y polarization Q-ch transmission DATA2 having the same electric signal amplitude are respectively input into four MZ type optical modulation devices.

FIG. 5 illustrates the eye pattern of the transmission DATA1 and the optical output strength of the modulation signal of X polarization (X polarization I-ch signal and X polarization Q-ch signal) when the electric signal amplitude of the transmission data DATA1 that is output from the DATA driver 120 to the first modulation unit 132 is changed from 1.0 times to 0.9 times and 0.8 times. In this simulation, 2 Vpi which yields the maximum optical output is adopted as the reference.

As can be understood from FIG. 5, the electric signal amplitude of the transmission data DATA1 is chanted from 1.0 times to 0.9 times and 0.8 times, so that the level of the eye pattern of the transmission data DATA1 decreases from 0.50 to 0.45 and 0.40.

Then, the electric signal amplitude of the transmission data DATA1 is changed from 1.0 times to 0.9 times and 0.8 times, the levels of the optical output strengths of the modulation signals of X polarization (X polarization I-ch transmission DATA1 and X polarization Q-ch transmission DATA1) which is output from the modulation device 130 decrease from 0.010 to 0.0098 and 0.009.

As can be understood from the simulation result, the electric signal amplitudes of the transmission data DATA1 and the transmission data DATA2 which are output to the modulation device 130 are adjusted, so that the level of the modulation signal of X polarization and the level of the modulation signal of Y polarization can be controlled with high accuracy.

Therefore, the electric signal amplitudes of the transmission data DATA1 and the transmission data DATA2 are adjusted based on the ratio of the output strengths of the pilot signals retrieved from the modulation signal that is output from the modulation device 130, so that PDL suppression with high accuracy can be performed even in a case where the optical transmission device 100 performs QPSK modulation.

Here, in an optical transmission system having the optical transmission device 100 provided therein, PDL occurs in multiple devices such as an optical amplification device, a relay device, and the like. In this case, pilot signals may be retrieved at a transmission end of the optical transmission system, and the optical transmission device 100 may adjust the electric signal amplitude of the transmission data DATA in such a way that the PDL at the transmission end becomes zero.

The invention of the present application is not limited to the above exemplary embodiment, and even when a design change and the like occurs within a range not deviating from the gist of this invention, such cases are included in this invention.

### INDUSTRIAL APPLICABILITY

The invention of the present application can be widely applied to a digital optical transmission device using an LN modulation device, and a digital coherent optical communication system having the digital optical transmission device provided therein.

This application claims the priority based on Japanese Patent Application No. 2014-034033 filed on Feb. 25, 2014, and the entire disclosure thereof is incorporated herein by reference.

### REFERENCE SIGNS LIST

10 optical transmission device
20 optical output means
30 data output means
40 driving means
50 optical modulation device
51 split means
52 first modulation means
53 second modulation means
54 combining means
60 control means
100 optical transmission device
110 light source
120 DATA driver
130 modulation device
131 splitting device
132 first modulation unit
133 second modulation unit
134 combining unit
140 first bias control circuit
150 second bias control circuit

1. An optical transmission device comprising:
an optical output unit that generates and outputs an optical signal;
a data output unit that generates and outputs first data and second data based on transmission information;
a driving unit that generates two voltages and generates, based on received bias control information, a first pilot signal and a second pilot signal of which frequencies are different from each other, and superimposing the first pilot signal and the second pilot signal to the two voltages to output the voltages as a first bias voltage and a second bias voltage;
an optical modulation device including a split unit that splitting the output optical signal into two optical signals, a first modulation unit driven by the first bias voltage that modulates one of the split optical signals based on the output first data, and outputs a first modulation signal, a second modulation unit driven by the second bias voltage that modulates the other of the split optical signals based on the output second data, and outputs a second modulation signal, and a combining unit that combines the first modulation signal and second modulation signal and outputs a modulation signal; and
a control unit that extracts the first pilot signal and the second pilot signal from the output modulation signal, and generates and outputs the bias control information based on a strength ratio of the extracted first pilot signal and the extracted second pilot signal.

2. The optical transmission device according to claim 1, wherein the first pilot signal and the second pilot signal are signals in a low frequency region.

3. The optical transmission device according to claim 1, wherein the data output unit adjusts and outputs amplitudes of the first data and the second data in such a way as to attain a predetermined magnitude based on the received amplitude information, and
the control unit generates and outputs the amplitude information based on a strength ratio of the extracted first pilot signal and the extracted second pilot signal.

4. The optical transmission device according to claim 1, wherein the split unit outputs an X polarization optical signal to the first modulation unit, and outputs a Y polarization optical signal to the second modulation unit.

5. An optical transmission method using an optical modulation device including a split unit that splits a received optical signal into two optical signals, a first modulation unit driven by the first bias voltage that modulates one of the split optical signals based on first data, and outputs a first modulation signal, a second modulation unit driven by the second bias voltage that modulates the other of the split optical signals based on second data, and outputs a second modulation signal, and a combining unit that combines the first modulation signal and second modulation signal and outputs a modulation signal,
the optical transmission method comprising:
generating an optical signal and outputting the optical signal to the optical modulation device;
extracting a first pilot signal and a second pilot signal from the output modulation signal, and generating and outputting bias control information based on a strength ratio of the first pilot signal and the second pilot signal;
generating the first data and the second data based on transmission information and outputting the first data and the second data to the optical modulation device; and
generating two voltages based on the output bias control information and superimposing a first pilot signal and a second pilot signal of which frequencies are different from each other to the two generated voltages to output the voltages to the optical modulation device as a first bias voltage and a second bias voltage.

6. The optical transmission method according to claim 5, wherein the first pilot signal and the second pilot signal are signals in a low frequency region.

7. The optical transmission method according to claim 5, further comprising generating and outputting the amplitude information based on a strength ratio of the first pilot signal and the second pilot signal, and
adjusting amplitudes of the generated first data and the generated second data in such a way as to attain a predetermined magnitude based on the output amplitude information, and outputting the first data and the second data to the optical modulation device.

8. The optical transmission method according to claim 5, wherein the split unit outputs an X polarization optical signal to the first modulation unit, and outputs a Y polarization optical signal to the second modulation unit.

9. The optical transmission device according to claim 2, wherein the data output unit adjusts and outputs amplitudes of the first data and the second data in such a way as to attain a predetermined magnitude based on the received amplitude information, and
the control unit generates and outputs the amplitude information based on a strength ratio of the extracted first pilot signal and the extracted second pilot signal.

10. The optical transmission device according to claim 2, wherein the split unit outputs an X polarization optical signal to the first modulation unit, and outputs a Y polarization optical signal to the second modulation unit.

11. The optical transmission device according to claim 3, wherein the split unit outputs an X polarization optical signal to the first modulation unit, and outputs a Y polarization optical signal to the second modulation unit.

12. The optical transmission device according to claim 9, wherein the split unit outputs an X polarization optical signal to the first modulation unit, and outputs a Y polarization optical signal to the second modulation unit.

13. The optical transmission method according to claim 6, further comprising generating and outputting the amplitude information based on a strength ratio of the first pilot signal and the second pilot signal, and
adjusting amplitudes of the generated first data and the generated second data in such a way as to attain a predetermined magnitude based on the output amplitude information, and outputting the first data and the second data to the optical modulation device.

14. The optical transmission method according to 6, wherein the split unit outputs an X polarization optical signal to the first modulation unit, and outputs a Y polarization optical signal to the second modulation unit.

15. The optical transmission method according to 7, wherein the split unit outputs an X polarization optical signal to the first modulation unit, and outputs a Y polarization optical signal to the second modulation unit.

16. The optical transmission method according to 13, wherein the split unit outputs an X polarization optical signal to the first modulation unit, and outputs a Y polarization optical signal to the second modulation unit.

17. An optical transmission device comprising:
optical output means for generating and outputting an optical signal;
data output means for generating and outputting first data and second data based on transmission information;
driving means for generating two voltages and generating, based on received bias control information, a first pilot signal and a second pilot signal of which frequencies are different from each other, and superimposing the first pilot signal and the second pilot signal to the two voltages to output the voltages as a first bias voltage and a second bias voltage;
an optical modulation device including split means for splitting the output optical signal into two optical signals, first modulation means driven by the first bias voltage for modulating one of the split optical signals based on the output first data, and outputting a first modulation signal, second modulation means driven by the second bias voltage for modulating the other of the split optical signals based on the output second data, and outputting a second modulation signal, and a combining means for combining the first modulation signal and second modulation signal and outputting a modulation signal; and
control means for extracting the first pilot signal and the second pilot signal from the output modulation signal, and generating and outputting the bias control information based on a strength ratio of the extracted first pilot signal and the extracted second pilot signal.
